(19) United States
(12) Patent Application Publication
(10) Pub. No.: US 2003/0135521 A1
(43) Pub. Date: Jul. 17, 2003

(54) Microelectronic fabrication facility on-line microelectronic fabrication product order information system

(75) Inventor: Chiung-Hwa Liu, Hsin-chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/047,162

(22) Filed: Jan. 14, 2002

(51) Int. Cl. G06F 12/00

(52) U.S. Cl. 707/200

(57) ABSTRACT

Within both a microelectronic fabrication facility information system and a method for operating the microelectronic fabrication facility information system there is provided a series of databases having contained therein production information for microelectronic fabrication product orders within a microelectronic fabrication facility. Within the system and method there is also provided a microelectronic fabrication facility communication interface connected to the series of databases, where the microelectronic fabrication facility communication interface serves as an interface to a distributed communication network and functions in a fashion which allows a microelectronic fabrication customer also connected to the distributed communications network to access the information within the series of databases.

### BACKGROUND OF THE INVENTION

1. Field of the Invention

The present invention relates generally to microelectronic fabrication facilities. More particularly, the present invention relates to information systems employed within microelectronic fabrication facilities.

2. Description of the Related Art

Microelectronic fabrications, such as semiconductor integrated circuit microelectronic fabrications, are fabricated within microelectronic fabrication facilities while generally employing complex multi-step microelectronic fabrication process sequences which in turn employ a selected and complex correlating sequencing of microelectronic fabrication tools.

While such a considerable complexity of microelectronic fabrication processing requirements is generally essential within the art of microelectronic fabrication for fabricating microelectronic fabrications, and typically unavoidable within the art of microelectronic fabrication for fabricating microelectronic fabrications, such a considerable complexity of microelectronic fabrication processing requirements is nonetheless not entirely without problems in the art of microelectronic fabrication.

In that regard, due to the considerable complexity of microelectronic fabrication processing requirements when fabricating microelectronic fabrications it is often difficult in the art of microelectronic fabrication to provide updated and accurate status to microelectronic fabrication customers of microelectronic fabrication orders fabricated within microelectronic fabrication facilities.

It is thus desirable in the art of microelectronic fabrication to provide methods and systems wherein microelectronic fabrication customers may receive accurate and timely status of microelectronic fabrication orders fabricated within microelectronic fabrication facilities.

It is towards the foregoing object that the present invention is directed.

Various methods and systems have been disclosed within arts, including but not limited to microelectronic fabrication arts, for purposes of facilitating information transfer within arts including but not limited to microelectronic fabrication arts.

Included among the methods and systems, but not limiting among the methods and systems, are methods and systems disclosed within: (1) Chin et al., in U.S. Pat. No. 5,818,716 (a method and a system for dynamically dispatching microelectronic fabrication work in process (WIP) workload within a microelectronic fabrication facility to provide precise and efficient microelectronic fabrication production from the microelectronic fabrication facility, by considering in a first instance a customer provided required delivery date for a microelectronic fabrication product fabricated within the microelectronic fabrication facility); and (2) Blinn et al., in U.S. Pat. No. 5,987,622 (an on-line electronic commerce shopping and merchandising system which may be flexibly and efficiently implemented, by designing and structuring the on-line electronic commerce shopping and merchandising system such as to be adaptable to databases provided in various schema).

Desirable in the art of microelectronic fabrication are methods and systems which efficiently provide microelectronic fabrication product status when fabricating microelectronic fabrications.

It is towards the foregoing object that the present invention is directed.

### SUMMARY OF THE INVENTION

A first object of the present invention is to provide a method and a system which provides microelectronic fabrication product order status when fabricating a microelectronic fabrication.

A second object of the present invention is to provide a method and a system in accord with the first object of the present invention, wherein the microelectronic fabrication product order status is readily available to a microelectronic fabrication customer for whom the microelectronic fabrication product is fabricated.

A third object of the present invention is to provide a method and a system in accord with the first object of the present invention and the second object of the present invention, wherein the method and the system are readily commercially implemented.

In accord with the objects of the present invention, there is provided by the present invention a microelectronic fabrication facility information system and a method for operating the microelectronic fabrication facility information system.

In accord with the present invention, the microelectronic fabrication facility information system comprises in a first instance a series of databases having contained therein production information for microelectronic fabrication product orders within a microelectronic fabrication facility. The microelectronic fabrication facility information system comprises in a second instance a microelectronic fabrication facility communication interface connected to the series of databases, where the microelectronic fabrication facility communication interface serves as an interface to a distributed communication network and functions in a fashion which allows a microelectronic fabrication customer also connected to the distributed communications network to access the information within the series of databases.

The microelectronic fabrication facility information system of the present invention contemplates a method for operating the microelectronic fabrication facility information system in accord with the present invention.

The present invention provides a method and a system which provides microelectronic fabrication product order status when fabricating a microelectronic fabrication, wherein the microelectronic fabrication product order status is readily available to a microelectronic fabrication customer for whom the microelectronic fabrication product is fabricated.

The present invention realizes the foregoing object by providing, for use within a microelectronic fabrication facility, a microelectronic fabrication facility information system which allows for direct on-line access by a microelectronic fabrication customer of microelectronic fabrication product order information within a series of databases which in turn comprises the microelectronic fabrication facility information system.

The method of the present invention and the system of the present invention are readily commercially implemented.

As will be illustrated in greater detail within the context of the Description of the Preferred Embodiment, as set forth below, the present invention employs components and systems as are otherwise generally known within arts including but not limited to microelectronic fabrication arts, but assembled and operated to provide the method of the present invention and the system of the present invention.

Since it is thus at least in part a specific application of components and systems which provides at least in part the present invention, rather than the existence of components and systems which provides at least in part the present invention, the method of the present invention and the system of the present invention are readily commercially implemented.

### BRIEF DESCRIPTION OF THE DRAWINGS

The objects, features and advantages of the present invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic block diagram illustrating a series of components which may be assembled to provide a microelectronic fabrication facility information system in accord with a preferred embodiment of the present invention.

FIG. 2 shows a representation of a microelectronic fabrication customer user interface screen which may be provided by the microelectronic fabrication facility information system in accord with the preferred embodiment of the present invention.

### DESCRIPTION OF THE PREFERRED EMBODIMENT

The present invention provides a method and a system which provides microelectronic fabrication product order status when fabricating a microelectronic fabrication, wherein the microelectronic fabrication product order status is readily available to a microelectronic fabrication customer for whom the microelectronic fabrication product is fabricated.

The present invention realizes the foregoing object by providing, for use within a microelectronic fabrication facility, a microelectronic fabrication facility information system which allows for direct on-line access by a microelectronic fabrication customer of microelectronic fabrication product order information within a series of databases which in turn comprises the microelectronic fabrication facility information system.

Although the preferred embodiment of the present invention describes the present invention most particularly within the context of a microelectronic fabrication facility information system which is employed most particularly within a semiconductor integrated circuit microelectronic fabrication facility, the present invention may nonetheless provide a microelectronic fabrication facility information system for use within any of several types of microelectronic fabrication facilities. In that regard, the present invention may provide a microelectronic fabrication facility information system which may be employed within a microelectronic fabrication facility selected from the group including but not limited to semiconductor integrated circuit microelectronic fabrication facilities, ceramic substrate microelectronic fabrication facilities, solar cell optoelectronic microelectronic fabrication facilities, sensor image array optoelectronic microelectronic fabrication facilities and display image array optoelectronic microelectronic fabrication facilities.

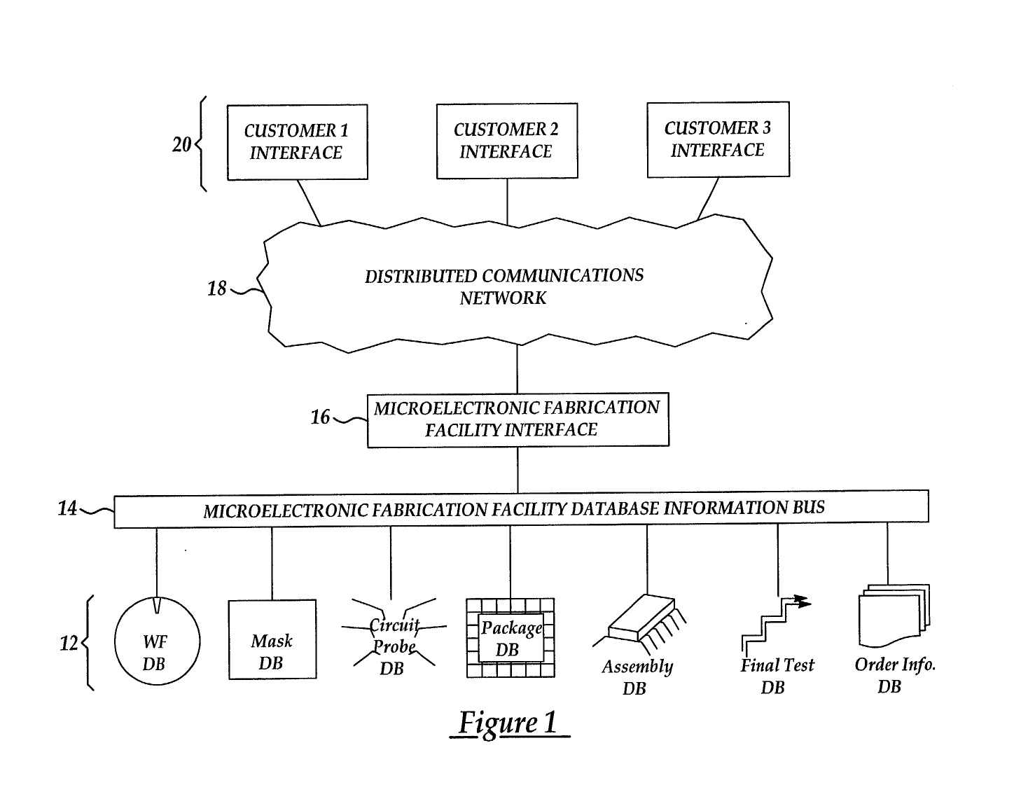

Referring now to FIG. 1, there is shown a schematic block diagram illustrating a microelectronic fabrication facility information system employed within a semiconductor integrated circuit microelectronic fabrication facility in accord with a preferred embodiment of the present invention.

Shown in FIG. 1, and in accord with a block of icons which corresponds with reference numeral 12, there is shown a series of databases within which is stored data and information which is generated incident fabricating a series of semiconductor integrated circuit microelectronic fabrications within the semiconductor integrated circuit microelectronic fabrication facility. As is illustrated within the schematic diagram of FIG. 1, the series of databases includes, but is not limited to, a wafer properties database 12a, a mask selection database 12b, a circuit probe database 12c, a circuit packaging database 12d, a chip assembly database 12e, a final test database 12f and an order information database 12g.

Within the preferred embodiment of the present invention, data and information is entered into the foregoing series of databases by appropriate engineering and administrative representatives of the semiconductor integrated circuit microelectronic fabrication facility, generally contemporaneously with the generation of the data and information.

Also shown within the schematic diagram of FIG. 1 is a microelectronic fabrication facility database information bus 14 which provides a connection to each of the databases as illustrated in accord with the series of icons which corresponds with reference numeral 12. As is understood by a person skilled in the art, the microelectronic fabrication facility database information bus 14 may be provided while employing any of several database communication components as are conventional in the art of information systems fabrication, including but not limited to hard wired database communication components and wireless database communications components.

As is further illustrated within the schematic block diagram of FIG. 1, the microelectronic fabrication facility database information bus 14 is further connected to a microelectronic fabrication facility interface 16 which in turn is connected to a distributed communications network 16. Again, and in general in accord with the present invention, the foregoing connections may be hard wired connections or wireless connections.

Within the preferred embodiment of the present invention, the microelectronic fabrication facility interface 16 is typically and preferably provided as a hardware interface which is generally consists of or comprises a server. Similarly, the server may have contained integral thereto the microelectronic fabrication facility information bus 14 and the series of databases which correspond with the series of icons which correspond with reference numeral 12.

Within the preferred embodiment of the present invention with respect to the distributed communication network 16, the distributed communication network is typically and preferably an Internet distributed communications network, although the present invention and the preferred embodiment of the present invention may employ distributed communications networks including but not limited to Internet distributed communications networks, intranet distributed communications networks, local area network (LAN) distributed communications networks and wide area network (WAN) distributed communications networks.

Finally, there is illustrated within the schematic block diagram of FIG. 1, and in accord with a series of blocks which corresponds with reference numeral 20, a series of customer interfaces 20a, 20b and 20c, which also provide access to the distributed communications network 18.

Within the preferred embodiment of the present invention, the microelectronic fabrication facility interface 16 is designed such as to provide access for each of the customers within the series of customer interfaces 20a, 20b and 20c in accord with the series of blocks which correspond with reference numeral 20 to the information and data which is contained with the series of databases in accord with the series of icons which correspond with reference numeral 12. Thus, in accord with the preferred embodiment of the present invention, a customer within one of the series of customer interfaces 20a, 20b and 20c in accord with the series of blocks which corresponds with reference numeral 20 need not individually interface with a microelectronic fabrication facility engineering or administrative representative when obtaining information pertaining to a customer's microelectronic fabrication order within the microelectronic fabrication facility.

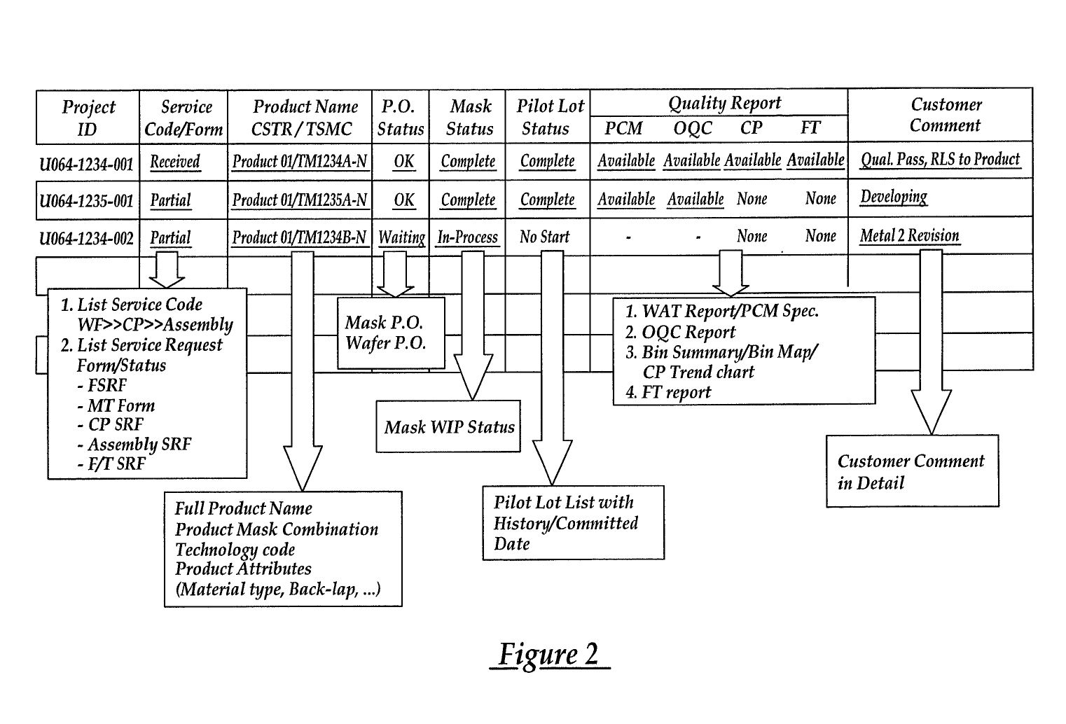

Referring now to FIG. 2, there is shown an annotated representation of a customer user interface screen which may be accessed by a customer incident to operation of the microelectronic fabrication facility information system in accord with the preferred embodiment of the present invention, as illustrated within the schematic block diagram of FIG. 1.

Shown in FIG. 2 is a series of columns, each having a column heading, and where several of the columns bear a relationship with respect to the series of databases whose icons correspond with reference numeral 12 within FIG. 1. Similarly, there is also shown within the tabular representation of FIG. 2 annotational information for columns other than a Project identification Number column which is intended to represent a unique product order identifier for a particular microelectronic fabrication customer and a particular microelectronic fabrication customer order within the microelectronic fabrication facility.

With respect to the Service Code/Form column, the Service Code/Form column it is intended to provide a representation of sufficiency of microelectronic fabrication product order documentation provided by a microelectronic fabrication customer for a specific microelectronic fabrication product order within the microelectronic fabrication facility. Microelectronic fabrication customer access of further information supporting the Service Code/Form column is intended as indicative of completion of various service request forms (SRF) intended to be received by the microelectronic fabrication facility, such that a particular microelectronic fabrication order may be effectively completed.

With respect to the Product Name column, the annotated information accompanying the Product Name column is intended to indicate underlying information regarding product mask combinations, technology codes and other product attributes for a microelectronic fabrication product fabricated within the microelectronic fabrication facility.

With respect to the Purchase Order Status column, the annotated information with respect to the Purchase Order Status column is intended to indicate that the Purchase Order Status column provides underlying information related to both mask purchase orders and wafer purchase orders.

With respect to the Quality Report column, the sub-columns and the annotated information within the Quality Report column are intended as indicative of availability of any of several quality reports for a particular microelectronic fabrication product order fabricated within a microelectronic fabrication facility. The quality reports may include, but are not limited to, process control monitor (PCM) quality reports, outgoing quality control (OQC) quality reports, final test (FT) quality reports, wafer acceptance test (WAT) quality reports and various summary charts.

With respect to the Mask Status column, the Pilot Lot Status column and the Customer Comment column, annotational information with respect to those columns is intended as self explanatory within the context of FIG. 2.

As is understood by a person skilled in the art, the underlying annotated information with respect to any of the foregoing columns, or other columns, either illustrated or not illustrated, may be accessed while employing linking methods as are common in the art of information processing, including but not limited to hypertext linking methods.

Upon providing a microelectronic fabrication facility information system in accord with FIG. 1, in turn having a user interface screen in accord with the tabular representation of FIG. 2, which in turn is accessed by a microelectronic fabrication customer, there is provided by the present invention a method and a system which provides microelectronic fabrication product order status when fabricating a microelectronic fabrication, wherein the microelectronic fabrication product order status is readily available to a microelectronic fabrication customer for whom the microelectronic fabrication product is fabricated.

The present invention realizes the foregoing object by providing, for use within a microelectronic fabrication facility, a microelectronic fabrication facility information system which allows for direct on-line access by a microelectronic fabrication customer of microelectronic fabrication product order information within a series of databases which in turn comprises the microelectronic fabrication facility information system.

As is understood by a person skilled in the art, the preferred embodiment of the present invention is illustrative of the present invention rather than limiting of the present invention. Revisions and modifications may be made to methods systems and components which are employed within the context of the preferred embodiment of the present invention while still providing a method in accord with the present invention and a system in accord with the present invention, further in accord with the accompanying claims.

What is claimed is:

1. A microelectronic fabrication facility information system comprising:
a series of databases having contained therein production information for microelectronic fabrication product orders within a microelectronic fabrication facility; and
a microelectronic fabrication facility communication interface connected to the series of databases, where the microelectronic fabrication facility communication interface serves as an interface to a distributed communication network and functions in a fashion which allows a microelectronic fabrication customer also connected to the distributed communications network to access the information within the series of databases.

2. The system of claim 1 wherein the system is incorporated into a microelectronic fabrication facility selected from the group consisting of integrated circuit microelectronic fabrication facilities, ceramic substrate microelectronic fabrication facilities, solar cell optoelectronic microelectronic fabrication facilities, sensor image array optoelectronic microelectronic facilities and display image array optoelectronic microelectronic fabrication facilities.

3. The system of claim 1 wherein the microelectronic fabrication facility communication interface is a computer server.

4. The system of claim 3 wherein the computer server has incorporated therein the series of databases.

5. The system of claim 1 wherein the distributed communications network is selected from the group consisting of local area networks, wide area networks, Internet networks and intranet networks.

6. The system of claim 1 wherein the distributed communications network is an Internet distributed communications network.

7. A method for operating a microelectronic fabrication facility information system comprising:
providing a microelectronic fabrication facility information system comprising:
a series of databases having contained therein production information for microelectronic fabrication product orders within a microelectronic fabrication facility; and
a microelectronic fabrication facility communication interface connected to the series of databases, where the microelectronic fabrication facility communication interface serves as an interface to a distributed communication network and functions in a fashion which allows a microelectronic fabrication customer also connected to the distributed communications network to access the information within the series of databases;
providing the microelectronic fabrication customer connected to the distributed communications network; and
effecting access of the production information within the series of databases by the microelectronic fabrication customer through the distributed communications network.

8. The method of claim 7 wherein the system is incorporated into a microelectronic fabrication facility selected from the group consisting of integrated circuit microelectronic fabrication facilities, ceramic substrate microelectronic fabrication facilities, solar cell optoelectronic microelectronic fabrication facilities, sensor image array optoelectronic microelectronic facilities and display image array optoelectronic microelectronic fabrication facilities.

9. The method of claim 7 wherein the microelectronic fabrication facility communication interface is a computer server.

10. The method of claim 9 wherein the computer server has incorporated therein the series of databases.

11. The method of claim 7 wherein the distributed communications network is selected from the group consisting of local area networks, wide area networks, Internet networks and intranet networks.

12. The method of claim 7 wherein the distributed communications network is an Internet distributed communications network.
